(19) United States
(12) Patent Application Publication
(10) Pub. No.: US 2022/0318810 A1
(43) Pub. Date: Oct. 6, 2022

(54) SECURING GAMING ESTABLISHMENT RETAIL PURCHASES

(71) Applicant: IGT, Las Vegas, NV (US)

(72) Inventors: Jeffery Shepherd, Reno, NV (US); Kevin Higgins, Reno, NV (US)

(21) Appl. No.: 17/220,395

(22) Filed: Apr. 1, 2021

(51) Int. Cl. G06Q 20/40; G06Q 20/20; G07F 17/32

(52) U.S. Cl. CPC G06Q 20/4012; G06Q 20/405; G06Q 20/206; G07F 17/3244

(57) ABSTRACT

Systems and methods that operate to enhance security associated with gaming establishment retail and entertainment purchases made in association with a gaming establishment fund management system.

### BACKGROUND

In various embodiments, the systems and methods of the present disclosure operate to enhance security associated with gaming establishment retail and entertainment purchases made in association with a gaming establishment fund management system.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF SUMMARY

In certain embodiments, the present disclosure relates to a system including a processor, and a memory device that stores a plurality of instructions. When executed by the processor responsive to an attempted retail purchase at a point-of-sale terminal, the instructions cause the processor to determine if any enhanced security measures are associated with the attempted retail purchase. When executed by the processor responsive to the determination being that an enhanced security measure is associated with the attempted retail purchase, the instructions cause the processor to determine if the enhanced security measure is satisfied by a user. When executed by the processor responsive to the determination being that the enhanced security measure is satisfied and responsive to a determination that a balance of a gaming establishment account associated with the user includes at least an amount of funds to complete the attempted retail purchase, the instructions cause the processor to communicate data which results in the point-of-sale terminal completing the attempted retail purchase, and modify the balance of the gaming establishment account associated with the user based on an amount of funds to complete the attempted retail purchase. When executed by the processor responsive to the determination being that the enhanced security measure is not satisfied and responsive to the determination that the balance of the gaming establishment account associated with the user includes at least the amount of funds to complete the attempted retail purchase, the instructions cause the processor to communicate data which results in the point-of-sale terminal not completing the attempted retail purchase.

In certain embodiments, the present disclosure relates to a system including a processor, and a memory device that stores a plurality of instructions. When executed by the processor responsive to an attempted retail purchase at a point-of-sale terminal, the instructions cause the processor to determine if any enhanced security measures are associated with a gaming establishment account. When executed by the processor responsive to the determination being that an enhanced security measure is associated with the gaming establishment account and responsive to a determination that the enhanced security measure is satisfied by a user, the instructions cause the processor to determine if a balance of the gaming establishment account associated with the user includes at least an amount of funds to complete the attempted retail purchase. When executed by the processor responsive to the determination being that the enhanced security measure is associated with the gaming establishment account and responsive to a determination that the enhanced security measure is not satisfied by the user, the instructions cause the processor to communicate data which results in the point-of-sale terminal not completing the attempted retail purchase.

In certain embodiments, the present disclosure relates to a method of operating a system. Responsive to an attempted retail purchase at a point-of-sale terminal, the method includes determining, by a processor, if any enhanced security measures are associated with the attempted retail purchase. Responsive to the determination being that an enhanced security measure is associated with the attempted retail purchase, the method includes determining, by the processor, if the enhanced security measure is satisfied by a user. Responsive to the determination being that the enhanced security measure is satisfied and responsive to a determination that a balance of a gaming establishment account associated with the user includes at least an amount of funds to complete the attempted retail purchase, the method includes communicating data which results in the point-of-sale terminal completing the attempted retail purchase, and modifying, by the processor, the balance of the gaming establishment account associated with the user based on an amount of funds to complete the attempted retail purchase. Responsive to the determination being that the enhanced security measure is not satisfied and responsive to the determination that the balance of the gaming establishment account associated with the user includes at least the amount of funds to complete the attempted retail purchase, the method includes communicating data which results in the point-of-sale terminal not completing the attempted retail purchase.

Additional features are described herein, and will be apparent from the following Detailed Description and the figures.

### BRIEF DESCRIPTION OF THE SEVERAL VIEWS OF THE DRAWINGS

FIG. 1 is an example configuration of the architecture of a plurality of different components of the system of the present disclosure.

FIGS. 2A and 2B are example graphical user interfaces displayed in connection with requiring enhanced security measures in association with a purchase of goods and/or services using funds from a gaming establishment retail account.

### DETAILED DESCRIPTION

In various embodiments, the systems of the present disclosure enhances security associated with gaming establishment retail and entertainment purchases made in association with a gaming establishment fund management system.

In certain embodiments, in association with a user's attempt to utilize funds in a gaming establishment account, such as a gaming establishment retail account, to purchase goods and/or services at various touchpoints associated with a gaming establishment, the system employs one or more enhanced security measures for certain transactions to ensure that such purchases are authorized by the user associated with the gaming establishment account. That is, to reduce or prevent fraud and/or unauthorized access to the funds in a gaming establishment account associated with a user, upon a determination that the requested access of funds in a gaming establishment account warrant an additional level of verification, the system utilizes certain enhanced security measures to authenticate one or more attempted purchases prior to completing such purchases. In other words, to verify that the user attempting to make a purchase of goods and/or services with funds in a gaming establishment account is the same user as the user associated with the gaming establishment account, the system invokes one or more security features to reduce instances of fraud committed by fraudsters whom have gained access to the funds in a gaming establishment account associated with a user. In certain of these embodiments, the security features employed by the system include requiring additional information from the user, possibly using a secondary device separate from a point-of-sale terminal of a retail system, prior to completing any attempted transaction using funds in a gaming establishment account. In certain of these embodiments, the security features employed by the system additionally or alternatively include requiring one or more additional actions from the user, possibly using a secondary device separate from a point-of-sale terminal of a retail system, prior to completing any attempted transaction using funds in a gaming establishment account.

Accordingly, in view of the various channels of commerce present throughout a gaming establishment, the system of the present disclosure combats potential frauds being attempted within such channels of commerce via determining zero, one or more security protocols to apply in association with one or more transactions. Since certain gaming establishment patrons are uncomfortable venturing into a gaming establishment with large amounts of cash, the enhanced security measures of the present disclosure provides such gaming establishment patrons relatively more secure access to funds in one or more gaming establishment accounts (which, subject to these enhanced security measures, are readily usable in various channels of commerce throughout the gaming establishment) to provide a relatively safer, more secure environment for such gaming establishment patrons. Such a configuration of employing one or more components of the gaming establishment retail system to facilitate the purchases of goods and/or services while reducing risks of fraud associated with such purchases overcomes various security concerns associated with cash-based retail transactions (e.g., protecting patrons carrying cash to retail establishments), overcomes various health concerns associated with cash-based retail transactions (e.g., protecting patrons from using forms of currency that act as transmission vehicles for contagions), and encourages patrons to participate in an alternative, non-cash-based option for the patron to purchase goods and/or services from a retail establishment, thereby expanding the cashless ecosystem certain gaming establishments strive for.

In various embodiments, the present disclosure is directed to a gaming establishment fund management system including various components or sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user, such as a player and/or retail patron, collectively form a resort or enterprise account (i.e., an integrated resort or gaming establishment fund management wallet) that the user may access to transfer funds and/or view balance information amongst the various accounts associated with or otherwise maintained for the user.

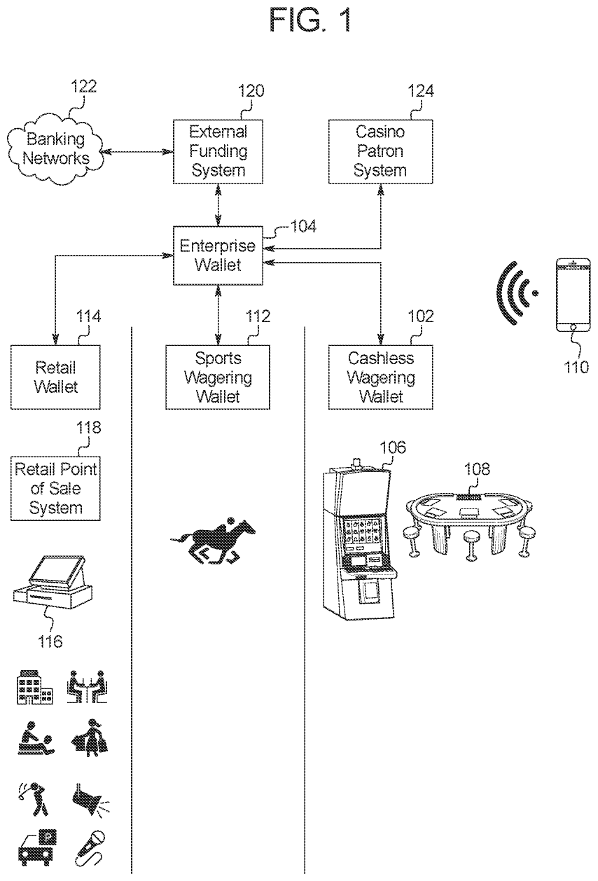

In various embodiments, the gaming establishment fund management system includes or is otherwise associated with one or more cashless wagering systems. Each cashless wagering system is associated with or otherwise maintain one or more cashless wagering accounts. In certain embodiments, the gaming establishment fund management system includes a first cashless wagering system that maintains a first cashless wagering account. In these embodiments, a user, such as a player of an electronic gaming machine (“EGM”), utilizes a mobile device application running on a mobile device and/or a physical instrument (e.g., a smart card or a user issued magnetic striped card which the user utilizes via inserting the card into a player tracking unit associated with the EGM) to facilitate the electronic transfer of any funds between this first cashless wagering account and a gaming device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system includes a first cashless wagering system (not shown) that maintains a Cashless Wagering Wallet 102 (e.g., a first cashless wagering account) which is in communication with the enterprise wallet 104. In this example, to facilitate the transfer of funds from this cashless wagering account to a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise associated with a second cashless wagering system that maintains a second cashless wagering account. In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the enterprise wallet 104. In this example, to facilitate the transfer of funds from this cashless wagering account to a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise associated with one or more gaming establishment retail wallet systems that each maintain one or more gaming establishment retail accounts. Such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 104. In this example, to facilitate the transfer of funds from this gaming establishment retail account to an account associated with a retailer to purchase goods and/or services from the retailer, the system utilizes a retail wallet identity, such as a mobile device 110 running a mobile device application that interfaces with a point-of-sale terminal 116 of a retail point-of-sale system 118 of the retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a retailer.

In certain embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In certain embodiments, the gaming establishment retail wallet systems which maintain one or more gaming establishment retail accounts are associated with zero, one or more spending controls or restrictions which determine whether or not zero, one or more security measures are employed to prevent unauthorized spending of the funds in such gaming establishment retail accounts. In certain embodiments, the retail point-of-sale systems are additionally or alternatively associated with zero, one or more spending controls or restrictions which determine whether or not zero, one or more security measures are employed to prevent unauthorized purchases of goods and/or services through such retail point-of-sale systems. In certain embodiments, the gaming establishment fund management system which maintains one or more gaming establishment accounts is associated with zero, one or more spending controls or restrictions which determine whether or not zero, one or more security measures are employed to prevent unauthorized spending of the funds in any gaming establishment retail accounts. In these embodiments, the gaming establishment retail wallet system, the retail point-of-sale system and/or the gaming establishment fund management system are in communication with or otherwise associated with one or more gaming establishment spending control systems to ensure that one or more purchases made using funds from a gaming establishment retail account comply with one or more restrictions associated with the use of such funds.

In certain embodiments, the gaming establishment spending control system is a separate system that operates with the gaming establishment retail wallet system, the retail point-of-sale system and/or the gaming establishment fund management system to verify the authenticity of one or more transactions involving funds from a gaming establishment retail account. In these embodiments, the gaming establishment retail wallet system, the retail point-of-sale system and/or the gaming establishment fund management system interrogates the gaming establishment spending control system before authorizing a transaction involving funds from a gaming establishment retail account to determine whether or not any spending controls or restrictions are in place and if so, how such spending controls or restrictions affect the potential action by the gaming establishment retail wallet system, the retail point-of-sale system and/or the gaming establishment fund management system.

In certain other embodiments, the gaming establishment spending control system is part of or otherwise built into the gaming establishment retail wallet system, the retail point-of-sale system and/or the gaming establishment fund management system and operates to verify the authenticity of one or more transactions involving funds from a gaming establishment retail account. In these embodiments, before authorizing a transaction involving funds from a gaming establishment retail account, the gaming establishment spending control system (i.e., a component of the gaming establishment retail wallet system, the retail point-of-sale system and/or the gaming establishment fund management system) determines whether or not any spending controls or restrictions are in place and if so, how such spending controls or restricts affect the potential action by the gaming establishment retail wallet system, the retail point-of-sale system and/or the gaming establishment fund management system. It should be appreciated that in different embodiments, any component or sub-system of the present disclosure can be in communication with one or more spending control systems.

In certain embodiments, the gaming establishment fund management system is in communication with one or more external funding sources which maintain one or more external accounts for the user. For example, as seen in FIG. 1, the gaming establishment fund management system that maintains the enterprise wallet 104 is in communication with an external funding system 120 which is in communication with a network of one or more banks or other financial institutions (i.e., the banking networks 122) which operate to electronically transfer funds to/from the user's accounts maintained at such banks or financial institutions to/from one or more of the accounts maintained by the gaming establishment fund management system. In certain embodiments, such external accounts include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that while illustrated as the gaming establishment fund management system being in communication with one or more external funding sources, in different embodiments, any component or sub-system of the present disclosure can be in communication with one or more external funding sources. In different embodiments, the system utilizes a mobile device running a mobile device application, a kiosk, a gaming device, a service window displayed by a gaming device (e.g., a remote host controlled service window displayed by an EGM), a component of a gaming establishment patron management system, such as a player tracking unit, and/or a gaming establishment interface to facilitate the transfer of funds to/from an external account.

In certain embodiments, the gaming establishment fund management system is in communication with one or more gaming establishment patron management systems. For example, as seen in FIG. 1, the gaming establishment fund management system (i.e., enterprise wallet 104) is in communication with one or more gaming establishment patron management systems (i.e., the casino patron system 124) that monitor activities at various points of contact associated with the gaming establishment and provides rewards, such as redeemable player tracking points, in association with such activities. It should be appreciated that while illustrated as the gaming establishment fund management system being in communication with one or more gaming establishment patron management systems, in different embodiments, any component or sub-system of the present disclosure can be in communication with one or more gaming establishment patron management systems. In different embodiments, the system utilizes a mobile device running a mobile device application, a kiosk, a gaming device, a service window displayed by a gaming device (e.g., a remote host controlled service window displayed by an EGM), a component of a gaming establishment patron management system, such as a player tracking unit, and/or a gaming establishment interface to interface with the gaming establishment patron management system.

In certain embodiments (not shown), the gaming establishment fund management system is in communication with one or more credit systems which each issue the user one or more lines of credit or markers. In these embodiments, to facilitate a transfer of funds from the line of credit issued by the credit system to a cashless wagering account (and then to a credit balance of an EGM and/or a credit balance of a gaming table component (not shown) associated with a gaming table) and/or to facilitate a transfer of funds from the line of credit issued by the credit system to a gaming establishment retail account (and then to a point-of-sale terminal of a retail point-of-sale system of a retailer), the system utilizes a mobile device running a mobile device application that interfaces with one or more components of the credit system and/or a physical instrument (e.g., a smart card or a user issued magnetic striped card) to enable a user, such as a player of the EGM or a player at the gaming table, to apply for a line of credit and/or access an amount of funds associated with an issued line of credit. It should be appreciated that in different embodiments, any component or sub-system of the present disclosure can be in communication with one or more credit systems.

In certain embodiments (not shown), the gaming establishment fund management system is also in communication with one or more credit reporting/credit risk systems which monitor and report on various accounts associated with the user. For example, the gaming establishment fund management system that maintains the enterprise wallet is in communication with one or more credit reporting and risk systems. These credit reporting and risk systems monitor and report on a credit rating and status of one or more accounts maintained for the user at various funding sources, such as various financial institutions. It should be appreciated that while illustrated as the gaming establishment fund management system being in communication with one or more credit reporting networks and one or more credit reporting/credit risk systems, in different embodiments, any component or sub-system of the present disclosure can be in communication with one or more credit reporting/credit risk systems.

In certain embodiments, the system utilizes one mobile device application to interact with the different components of the gaming establishment fund management system to, amongst other actions, access funds maintained in the different gaming establishment accounts associated with the user. For example, utilizing the same mobile application, a mobile device interacts with both the first cashless wagering system of the gaming establishment fund management system and the gaming establishment retail wallet system of the gaming establishment fund management system. In certain embodiments, the system utilizes multiple mobile device applications to interact with the different components of the gaming establishment fund management system to, amongst other actions, access funds maintained in the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

It should be appreciated that in different embodiments, in addition to or alternatively from utilizing a mobile device running a mobile device application to, amongst other actions, access funds associated with different gaming establishment accounts, the system utilizes a kiosk, an EGM, a service window displayed by a gaming device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to, amongst other actions, access the funds associated with such gaming establishment accounts. It should be further appreciated that while illustrated in FIG. 1 as using a mobile device running a mobile device application to access funds associated with different gaming establishment accounts (e.g., a cashless wagering account and a gaming establishment retail account), as mentioned above, a physical instrument, such as a smart card or a user issued magnetic striped card may additionally or alternatively be utilized to enable a user access to such gaming establishment account.

In various embodiments, prior to enabling a user to purchase goods and/or services with funds in a gaming establishment retail account subject to zero, one or more security features, a user, such as a player, must first open a gaming establishment retail account with a gaming establishment retail wallet system. In these embodiments, utilizing an interface, such as a mobile device application being executed by a mobile device, a website accessed from a browser and/or a service window displayed by EGM (or other gaming device), the user attempts to open a gaming establishment retail account through one or more interactive forms. For example, as part of opening a gaming establishment retail account, a user (whom has already logged into one or more gaming establishment fund management system accounts via a mobile device application) makes one or more inputs via an interface to provide certain user identifying information, such as, but not limited to, additional address details, a social security number and/or a mother's maiden name, and/or certain anticipated spending information, such as how the user intends to spend the funds withdrawn from such an account if opened.

In one such embodiment, in association with the opening of the account, the user is provided a physical instrument associated with the gaming establishment patron management system account and/or the gaming establishment account. In another such embodiment, the user is provided a code to activate their account and/or download a mobile identification (e.g., a mobile pass representing a player tracking card) via logging into a mobile device application associated with the gaming establishment or logging into a website associated with the gaming establishment. In another such embodiment, the user is sent a short message service (“SMS”) text and/or e-mail informing the user how to activate their account and/or download a mobile identification via logging into a mobile device application associated with the gaming establishment or logging into a website associated with the gaming establishment. In certain embodiments, the system enables a user, such as a retail patron and/or player of a gaming establishment device, to enroll or otherwise sign up for such accounts via other avenues, such as via picking up a retail account card at various locations, such as shops, throughout the gaming establishment, via a mobile application running on a mobile device, via a point-of-sale terminal, via an EGM, via a kiosk and/or via adding a retail account to an existing patron account, such as a player tracking account. In another embodiment, the system automatically creates a gaming establishment retail account for a player who is otherwise associated with another gaming establishment account, such as a cashless wagering account.

In certain embodiments, as part of an opening a gaming establishment retail account or in association with a previously opened gaming establishment retail account, the gaming establishment fund management system determines zero, one or more security measures to invoke in association with each transaction that uses funds from a user's gaming establishment retail account. In these embodiments, to prevent unauthorized access to the funds associated with the user's gaming establishment retail account, the system applies such determined security measures in association with any transaction that attempts to use funds from the user's gaming establishment retail account (and/or funds from zero, one or more other accounts maintained in association with the user).

In certain embodiments, as part of an opening a gaming establishment retail account or in association with a previously opened gaming establishment retail account, the gaming establishment fund management system determines one or more spending controls or restrictions to associate with the gaming establishment retail account wherein if such spending conditions are satisfied, the gaming establishment fund management system invokes one or more security measures. In these embodiments, to balance the need to prevent unauthorized access to the funds associated with the user's gaming establishment retail account against the need to provide a frictionless experience for users, the gaming establishment fund management system dynamically employs one or more security measures such that certain transactions that trigger the need employ enhanced security measures and certain transactions that do not trigger the need do not employ enhanced security measures.

It should be appreciated that an enhanced security measure includes any form of security that was not otherwise associated with the transaction prior to the determination that the nature of the transaction warranted an additional degree of protection to combat any attempted fraud associated with the transaction. For example, if a user is required to enter a personal identification number for each attempted purchase using funds from a gaming establishment retail account regardless of any determination that the nature of the transaction warrants any additional degree of protection to combat any attempted fraud associated with the transaction, such a personal identification number would not qualify as an enhanced security measure. In another example, if a user is not required to enter a personal identification number for each attempted purchase using funds from a gaming establishment retail account but following a determination that the nature of the transaction warrants requiring the user to enter a personal identification number as an additional degree of protection to combat any attempted fraud associated with the transaction, such a personal identification number would qualify as an enhanced security measure.

Following the gaming establishment fund management system and/or the gaming establishment retail system determines to authorize the user to make retail purchases subject to zero, one or more enhanced security measures, then following any required acknowledgement by the user of any required terms and conditions associated with using a gaming establishment retail account to purchase goods and/or services associated with the gaming establishment, the gaming establishment fund management system and/or the gaming establishment retail system notifies the user, if applicable, regarding the different ways the user may pay for retail purchases utilizing funding options provided by the gaming establishment fund management system and/or how to satisfy any enhanced security measures employed. For example, the gaming establishment fund management system and/or the gaming establishment retail system notifies the user, via one or more of a message displayed on a displayed message at a gaming establishment device (e.g., an EGM or a retail point-of-sale terminal), an email, a SMS or text message, and/or a notification displayed by a mobile device application.

In certain embodiments, the system enables the user to determine and activate zero, one or more spending conditions to associate with the gaming establishment retail account as well as zero, one or more security measures to employ. In these embodiments, if any user determined spending conditions are satisfied, the system attempts to prevent unauthorized access to the funds associated with the user's gaming establishment retail account by utilizing any user determined security measures. In certain embodiments, the determination to associate one or more enhanced security measures is based on one or more inputs from the user wherein the user indicates that they would like one or more enhanced security measures associated with certain of (or each of their purchases) made using funds from their gaming establishment retail account.

In certain embodiments, the system enables a gaming establishment operator to determine and activate zero, one or more spending conditions to associate with a gaming establishment retail account as well as zero, one or more security measures to employ. In these embodiments, if any gaming establishment operator determined spending conditions are satisfied, the system attempts to prevent unauthorized access to the funds associated with a user's gaming establishment retail account by utilizing any gaming establishment operator determined security measures. In certain embodiments, the determination to associate one or more enhanced security measures is based on one or more inputs from a gaming establishment operator wherein gaming establishment personnel indicate that they would like one or more enhanced security measures associated with certain of (or each of their purchases) made using funds from a user's gaming establishment retail account.

In certain embodiments, the system enables a retail point-of-sale system to determine and activate one or more spending conditions to associate with transactions undertaken by the retail point-of-sale system, wherein if such spending conditions are satisfied, the gaming establishment fund management system invokes one or more enhanced security measures. In certain of these embodiments, the determination to associate one or more enhanced security measures is based on one or more inputs from gaming establishment retail personnel whom indicate that they would like one or more enhanced security measures associated with certain of (or each of the purchases) made in association with the retail point-of-sale system. In certain other of these embodiments, the determination to associate one or more enhanced security measures is based on one or more settings associated with the gaming establishment retail point-of-sale system that dictate one or more enhanced security measures associated with certain of (or each of their purchases) made in association with the retail point-of-sale system. In certain embodiments, one or more determinations are made at the retail point-of-sale terminal level wherein different terminals are associated with different security measures. In certain embodiments, one or more determinations are made at the retail point-of-sale system level wherein each terminal is associated with the same security measures (which, as described below, may vary based on one or more attributes of the attempted transaction).

In certain embodiments, the spending conditions (that, if satisfied, trigger one or more enhanced security measures) are associated with the type of good and/or service of the retail purchase attempted to be made. In these embodiments, certain types of retail purchases trigger the use of one or more enhanced security features while other types of retail purchases do not trigger such enhanced security features. For example, a first category of purchases, such as food and beverage purchases, can be made using funds from a gaming establishment retail account without triggering any enhanced security features while a second category of purchases, such as clothing retail outlets and entertainment related charges, trigger one or more enhanced security features that must be satisfied before the completion of such purchases with funds from a gaming establishment retail account.

In certain embodiments, the spending conditions (that, if satisfied, trigger one or more enhanced security measures) are additionally or alternatively associated with the amount of the retail purchase attempted to be made. In these embodiments, certain retail purchases having a value above a threshold value trigger the use of one or more enhanced security features while other retail purchases that have a value below the threshold value do not trigger such enhanced security features. For example, retail purchases can be made using funds from a gaming establishment retail account without triggering any enhanced security features if such retail purchases are for less than $25, while retail purchases valued at $25 and above trigger one or more enhanced security features that must be satisfied before the completion of such purchases with funds from a gaming establishment retail account.

In certain embodiments, the spending conditions (that, if satisfied, trigger one or more enhanced security measures) are additionally or alternatively associated with a location of the retail purchase attempted to be made. In these embodiments, different locations where the funds from the gaming establishment retail account may be used are associated with different security measures required to use such funds. For example, retail purchases attempted in association with a first location, such as a gaming establishment gift shop, do not trigger the use of one or more enhanced security features while retail purchases attempted in association with a second location, such as a gaming establishment night club, trigger such enhanced security features.

In certain embodiments, the spending conditions (that, if satisfied, trigger one or more enhanced security measures) are additionally or alternatively associated with a channel of commerce in which the retail purchase is attempted to be made. In these embodiments, different channels of commerce where the funds from the gaming establishment retail account may be used are associated with different security measures required to use such funds. For example, based on historical information that funds spent at a first gaming establishment channel of commerce, such as a nightclub or concert venue, have a higher attempted fraud rate than funds drawn spent at a second gaming establishment channel of commerce, such as gaming establishment golf fees, the system triggers the use of one or more enhanced security features for attempted transactions within the first gaming establishment channel of commerce using funds from a gaming establishment retail account and does not trigger the use of such enhanced security features for attempted transactions within the second gaming establishment channel of commerce using funds from the gaming establishment retail account.

In certain embodiments, the spending conditions (that, if satisfied, trigger one or more enhanced security measures) are additionally or alternatively associated with a time of when the retail purchase is attempted to be made. In these embodiments, different times when the funds from the gaming establishment retail account are attempted to be used are associated with different security measures required to use such funds. For example, retail purchases attempted to made during a first period of time, such as from ten in the morning to ten in the evening do not trigger the use of one or more enhanced security features while retail purchases attempted in association with a second period of time, such as from midnight to eight in the morning trigger such enhanced security features.

In certain embodiments, the spending conditions (that, if satisfied, trigger one or more enhanced security measures) are additionally or alternatively associated with an amount of funds currently maintained in a gaming establishment retail account associated with a user. In one such embodiment, if an amount of funds above a threshold amount are currently in a gaming establishment retail account, the system triggers one or more enhanced security features while if the amount of funds below the threshold amount are currently in the gaming establishment retail account, the system does not trigger such enhanced security features. In another such embodiment, if an amount of funds below a threshold amount are currently in a gaming establishment retail account, the system triggers one or more enhanced security features while if the amount of funds above the threshold amount are currently in the gaming establishment retail account, the system does not trigger such enhanced security features.

In certain embodiments, the spending conditions (that, if satisfied, trigger one or more enhanced security measures) are additionally or alternatively associated with a current rate of consumption of the funds in one or more gaming establishment accounts maintained for the user. For example, if the rate of spending using funds from a gaming establishment retail account is below a threshold rate, the system does not trigger any enhanced security features, but if the rate of spending using funds from the gaming establishment retail account meets or exceeds the threshold rate, the system triggers the user of one or more enhanced security features. In one such embodiment, the rate of consumption is based on an amount of purchases made using funds from a gaming establishment retail account over a set period of time, such as the current day. In another such embodiment, the rate of consumption is based on an amount of purchases made using funds from a gaming establishment retail account over a rolling period of time, such as the past 24 hours.

It should be appreciated that in different embodiments, the system employs a combination of these spending conditions to determine whether or not any security measures need to be activated. For example, the spending conditions (that, if satisfied, trigger one or more enhanced security measures) are based on whether a total amount of retail purchases made at a designated location on certain type of goods and/or services using funds from a gaming establishment retail account are over a designated period of time. In this example, if the total amount of retail purchases made at the designated location on the identified type of goods and/or services using funds from the gaming establishment retail account over the designated period of time meet or exceed a threshold, then the system employs one or more enhanced security features.

In certain embodiments, the system employs the same spending controls and/or security measures for each user whom attempts to purchase goods and/or services with funds from a gaming establishment retail account. In certain embodiments, the system employs different spending controls and/or security measures for different users whom attempt to purchase goods and/or services with funds from a gaming establishment retail account. In certain of these embodiments, the system utilizes historical data regarding the user and past gaming establishment retail transactions in determining one or more aspects of one or more spending controls and/or security measures to associate with that user. In certain of these embodiments, the system utilizes one or more attributes of the user, such as a player tracking account status of the user, in determining one or more aspects of one or more spending controls and/or security measures to associate with that user.

In addition to authorizing the user to make retail purchases subject to zero, one or more security measures, in certain embodiments, upon the presentation of a retail wallet identity (e.g., a physical card associated with the gaming establishment retail account, a mobile device running a mobile device application associated with the gaming establishment retail account, or a mobile device that presents an identity associated with the user or the user's gaming establishment retail account) at an applicable point-of-sale terminal of a retail point-of-sale system within or otherwise associated with the gaming establishment for the purchase of goods and/or services, the system determines whether or not to complete the attempted retail purchase. For example, when a purchase of goods and/or services is attempted to be made with funds from a gaming establishment retail account using a mobile device application at a point-of-sale terminal, the mobile device application prompts the player to cause the mobile device to engage the point-of-sale terminal, such as prompting the player to tap the mobile device to a designated portion of the point-of-sale terminal (or otherwise moving the mobile device to within a designated distance of a designated location of the point-of-sale terminal). Such engagement initiates a pairing or linkage between the mobile device and the point-of-sale terminal (or a component of a gaming establishment fund management system located inside the point-of-sale terminal (i.e., a component of the point-of-sale terminal)), wherein the pairing or linkage between the mobile device and the point-of-sale terminal occurs via one or more applications being run or executed on the mobile device. In this example, after such engagement, the mobile device application communicates, via a wireless communication protocol (including, but not limited to: Bluetooth™, Bluetooth™ Low Energy (“BLE”), one or more cellular communication standards (e.g., 3G, 4G, 5G, LTE), one or more Wi-Fi compatible standards, and one or more short range communication protocols (e.g., a near field communication (“NFC”) protocol), data associated with the retail wallet identity to the point-of-sale terminal to facilitate the potential purchase of goods and/or services. In various embodiments, in addition to or alternative from attempting to make purchases of goods and/or services with funds in a gaming establishment retail account at a point-of-sale terminal, the system of the present disclosure enables a user to attempt to make purchases of goods and/or services with funds in a gaming establishment retail account via any suitable interface, such as a user interface of an EGM, a user interface of a gaming table component associated with a gaming table, a kiosk, a mobile device application being executed by a mobile device, a service window displayed by a gaming device (e.g., a remote host controlled service window displayed by an EGM), and/or a gaming establishment interface (e.g., a casino desk).

In various embodiments, upon receiving data or information regarding the retail wallet identity, the retail point-of-sale system communicates with the gaming establishment retail system (and/or the gaming establishment fund management system) to determine if the attempted purchase complies with any spending controls associated with the user's access to funds. For example, if one or more components of the gaming establishment system associate a spending control permitting food and beverage purchases to be made without any enhanced security measures, but requiring one or more enhanced security measures for purchases made for entertainment related charges, the gaming establishment retail system determines if the attempted purchase is for a food and beverage purchase (in which case the purchase may proceed without employing enhanced security measures) or for an entertainment purchase (in which case the purchase requires satisfaction of enhanced security measures). In another example, if one or more components of the gaming establishment system associate a spending control associated with the total amount of purchases to be charged per day, the gaming establishment retail system determines if the attempted purchase would cause the total amount of purchases charged for that day to remain below the limit (in which case the purchase may proceed without employing enhanced security measures) or reach or exceed the limit (in which case the purchase requires satisfaction of enhanced security measures). As illustrated by these examples, in certain instances, the system requires certain enhanced security measures be satisfied in association with the purchase of goods and/or services using funds from a gaming establishment retail account and in certain other instances the system does not require any enhanced security measures be satisfied in association with the purchase of goods and/or services using funds from a gaming establishment retail account. Such a configuration of determining, based on one or more aspects of the attempted retail transaction, whether or not any enhanced security measures are warranted provides a more secure system to reduce instances of fraud and/or unauthorized gaming establishment retail account access without unduly burdening the user in association with each transaction the user undertakes.

If the gaming establishment retail system (and/or another system, such as the gaming establishment fund management system) determines that the attempted purchase cannot be completed without first satisfying one or more enhanced security measures, the gaming establishment retail system (and/or another system, such as the gaming establishment fund management system) enables the user the opportunity to satisfy such enhanced security measures.

In certain embodiments, an enhanced security measure employed by the system of the present disclosure includes requiring the user to approve a retail transaction by entering a personal identification number (“PIN”) via a user interface (e.g., a mobile device application of the mobile device paired to the point-of-sale terminal and/or an interface of the point-of-sale terminal), providing a signature and/or presenting a biometric identifier to the employed user interface.

In certain embodiments, an enhanced security measure employed by the system of the present disclosure additionally or alternatively includes notifying the user prior to a purchase via a secondary communication channel and requesting the user to authorize the purchase via a response on the secondary communication channel. In these embodiments, in addition to or alternative from obtaining a PIN from the user, such as if the point-of-sale terminal does not support an interface capable of collecting a PIN from the user or if one or more aspects of the attempted transaction warrant more than collecting a PIN from a user, the system utilizes one or more secondary communication channels to invoke enhanced security measures to ensure the user attempted to make the purchase is the user associated with the gaming establishment retail account.

In one such embodiment, the system causes an SMS text including a uniform resource locator (“URL”) to be communicated to the user via the secondary communication channel, such as sending an SMS to the mobile device registered to the user (which may be the same mobile device utilized for the attempted purchase or a different mobile device). In this embodiment, the user accessing the URL (which includes or is otherwise associated with a transaction identifier that uniquely identifies the purchase attempt) would cause a notification to be sent from the user's mobile device to a backend server authorizing the attempted purchase as satisfying this enhanced security measure. On the other hand, the user failing to access the URL within a designated period of time after the SMS is sent would indicate that the user attempting to make the retail transaction is not the same user associated with the gaming establishment retail account and the backend server would take actions to designate the attempted purchase as not satisfying this enhanced security measure. In another embodiment, when accessing the URL, the user may be required to login to their player's club account to approve the purchase. Such an embodiment may avoid a purchase from being authorized via a scraper used when a URL is sent (e.g., as iOS creates an image representation).

In another such embodiment, the system causes an SMS to be communicated to the user via the secondary communication channel, such as sending an SMS to a mobile device registered to the user (which may be the same mobile device utilized for the attempted purchase or a different mobile device). In this embodiment, the user responding to the SMS with a reply SMS including an authorization of the purchase (e.g., the user responding “yes”) would cause the backend server to authorize the attempted purchase as satisfying this enhanced security measure. On the other hand, the user failing to respond to the SMS within a designated period of time after the SMS is sent (or the user responding declining the authorization of the purchase, such as the user responding “no”) would indicate that the user attempting to make the retail transaction is not the same user associated with the gaming establishment retail account and the backend server would take actions to designate the attempted purchase as not satisfying this enhanced security measure. In another embodiment, the system causes an SMS to be communicated to the user via the secondary communication channel, such as sending an SMS to a mobile device registered to the user, wherein a code which is part of the SMS needs to be inputted into a PIN pad associated with the point-of-sale terminal.

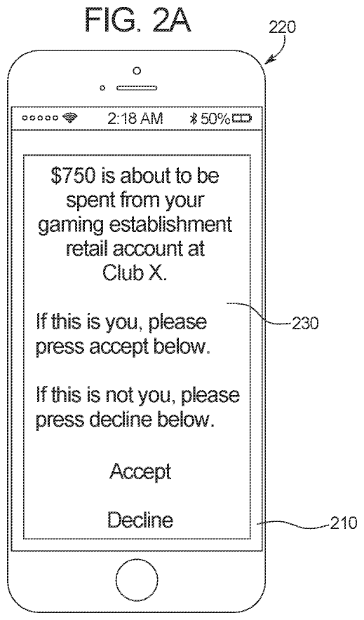

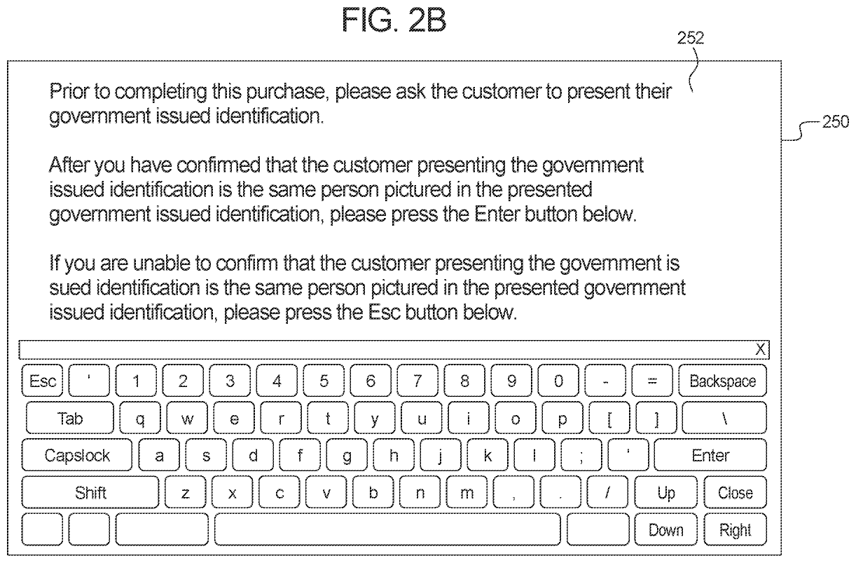

In another such embodiment, the system causes a push notification to be communicated to the user via the secondary communication channel, such as sending a push notification to the mobile device registered to the user (which may be the same mobile device utilized for the attempted purchase or a different mobile device). In this embodiment, the user selecting the push notification on the mobile device takes the user to a part of the mobile application running on the user's mobile device where the user can “approve” or “decline” the transaction by interfacing with the user interface of the mobile device application. For example, as seen in FIG. 2A, following a determination that a purchase using funds from a gaming establishment retail account is attempted to be made at a gaming establishment nightclub, a mobile device application 210 of a mobile device 220 registered to the user associated with the gaming establishment retail account displays a message 230 to a user informing the user of the attempted purchase and requesting the user to approve or decline the transaction.

In certain embodiments, an enhanced security measure employed by the system of the present disclosure additionally or alternatively includes requiring that picture identification documentation provided by the user is verified by staff member of the retail establishment. In certain embodiments, the picture identification documentation includes any government issued picture identification document, such as a government issued passport or passport card, a government issued driver's license, a government issued identification card, a native tribal card or a keypass identity card. In certain other embodiments, the picture identification documentation includes any non-government issued picture identification document, such as a company issued identification card. In these embodiments, upon a determination that a verification of the identity of the user is required, the system notifies the staff member of the retail establishment, such as via a display of the point-of-sale terminal or a display of an indicator associated with a self-service point-of-sale terminal (to notify a nearby staff member) that validation of the user's picture identification documentation is required to complete the purchase. Upon receipt of this notification, the staff member may engage the user, ask them to present their picture identification documentation, and upon successful validation, the staff member can interface with the point-of-sale terminal to indicate that the user's picture identification documentation has been validated and the user has satisfied the enhanced security measures associated with the attempted transaction. For example, as seen in FIG. 2B, following a determination that the price of the goods and/or services attempted to be purchased would cause a total retail spend for the user to exceed a threshold and trigger the employment of enhanced security measures, a display device of a point-of-sale terminal 250 informs the retail establishment personnel that a validation of the user's government issued identification is required prior to completing the transaction 252. In certain embodiments, the system automates this process by capturing one or more images of the user at the point-of-sale terminal and one or more images of any presented picture identification documentation and comparing facial recognition data of a user identified via an image of a presented picture identification document to the facial recognition data of a user to automatically verify the identity of the user without requesting the user to interact with retail establishment personnel.

In certain embodiments, if the user is unable to satisfy the enhanced security measures (or unable to satisfy the enhanced security measures after a designated quantity of attempts or within a designated period of time), the system declines the attempted transaction using funds from the gaming establishment retail account. In certain embodiments, in addition to not completing the attempted transaction, the system notifies the user of the failure to satisfy such security measures, such as by utilizing a backup communication channel previously established by the user (in case the user's mobile device is compromised and being used by a fraudster in one or more attempted transactions). In certain embodiments, in addition to not completing the attempted transaction, the system locks the gaming establishment retail account (and zero, one or more other gaming establishment accounts associated with the user) thereby preventing any transactions from occurring using funds from such accounts until the user unlocks such accounts, such as by interfacing with gaming establishment personnel. In certain embodiments, in addition to not completing the attempted transaction, the system notifies authorities of the attempted fraudulent transaction to aid authorities in apprehending the person attempting to access the funds in the user's account without authority.

In certain embodiments, following a satisfaction of one or more enhanced security measures or if the gaming establishment retail system (and/or another system, such as the gaming establishment fund management system) determines that the attempted purchase may be completed without satisfying any enhanced security measures, the retail point-of-sale system communicates with the gaming establishment retail wallet system to determine if the gaming establishment retail account has adequate funds for the intended purchase. In these embodiments, to reduce unnecessary communications and determinations by the system (and thus reduce computational stress on the processors of the system), the system first determines that the attempted purchase satisfies any invoked security measures before determining if the attempted purchase can be completed based on the amount of funds currently associated with the gaming establishment retail account. In certain other embodiments, to also reduce unnecessary communications and determinations by the system (and thus reduce computational stress on the processors of the system), the system first determines if the attempted purchase can be completed based on the amount of funds currently associated with the gaming establishment retail account and if so, the system then determines if the attempted purchase satisfies any invoked security measures.

If the gaming establishment retail wallet system confirms the presence of adequate funds in the gaming establishment retail account, the retail point-of-sale system authorizes the sale of the goods and/or services. In this instant, the gaming establishment retail wallet system proceeds to transfer an amount of funds to cover the purchased goods and/or services from the gaming establishment retail account to an account associated with the retail point-of-sale system (and/or the retail establishment) to complete the purchase of the goods and/or services. On the other hand, if the gaming establishment retail wallet system indicates that the gaming establishment retail account lacks adequate funds for the purchase, the retail point-of-sale system denies this sale transaction of the goods and/or services using the gaming establishment retail account.

In certain embodiments, following the completion of the purchase with funds associated with a gaming establishment retail account and/or following a determination that a purchase with funds associated with a gaming establishment retail account cannot be completed, the system notifies the user via one or more employed interfaces. In one such embodiment wherein the user employed a mobile device paired with a point-of-sale terminal in association with the transaction, the point-of-sale terminal and/or the mobile device provide such a notification to the user, such as the point-of-sale terminal printing a receipt of a completed transaction or a mobile device application displaying a message regarding the transaction. In another such embodiment, the system notifies the user via a secondary communication channel, such as via sending an email, SMS, and/or mobile device application notification, regarding the attempted transaction. In another such embodiment, the system notifies the user via a secondary communication channel, such as via sending an email, SMS, and/or mobile device application notification, regarding any post-transaction activity, such as informing the user via the secondary communication channel that a return of a previously purchased good has occurred.

Accordingly, in view of the various channels of commerce present throughout a gaming establishment, the system of the present disclosure combats potential frauds being attempted within such channels of commerce via determining zero, one or more security protocols to apply in association with one or more transactions. Since certain gaming establishment patrons are uncomfortable venturing into a gaming establishment with large amounts of cash, the enhanced security measures of the present disclosure provides such gaming establishment patrons relatively more secure access to funds in one or more gaming establishment accounts (which, subject to these enhanced security measures, are readily usable in various channels of commerce throughout the gaming establishment) to provide a relatively safer, more secure environment for such gaming establishment patrons. Such a configuration of employing one or more components of the gaming establishment retail system to facilitate the purchases of goods and/or services while reducing risks of fraud associated with such purchases overcomes various security concerns associated with cash-based retail transactions (e.g., protecting patrons carrying cash to retail establishments), overcomes various health concerns associated with cash-based retail transactions (e.g., protecting patrons from using forms of currency that act as transmission vehicles for contagions), and encourages patrons to participate in an alternative, non-cash-based option for the patron to purchase goods and/or services from a retail establishment, thereby expanding the cashless ecosystem certain gaming establishments strive for.

In various embodiments, prior to using funds in a gaming establishment retail account to purchase goods and/or services (subject to zero, one or more spending controls and any associated security measures employed), the system enables the gaming establishment retail account to be funded from one or more sources. In certain embodiments, the system enables the gaming establishment retail account to be directly funded from one or more of such sources. In certain embodiments, the system enables the gaming establishment retail account to be indirectly funded from one or more of such sources, such as by an amount of funds from such sources first being transferred to another gaming establishment account and then such an amount of funds being transferred from the other gaming establishment account to the gaming establishment retail account.

In certain embodiments, the gaming establishment fund management account is associated with one or more external accounts, such as one or more credit card accounts, one or more debit card accounts and/or one or more third-party maintained accounts (e.g., one or more PayPal® accounts or Venmo® accounts). In certain embodiments, the gaming establishment fund management account is associated with a gaming establishment or a group of gaming establishments, wherein the user establishes a gaming establishment fund management account, such as a gaming establishment retail account, by a deposit of funds (such as at a kiosk) to be subsequently utilized in association with the mobile device application. In other embodiments, the gaming establishment fund management account, such as a gaming establishment retail account, is funded via a mobile device electronic fund transfer, such using Apple Pay™ or Android Pay™. It should be appreciated that in different embodiments, the system utilizes a mobile device running a mobile device application, a kiosk, an EGM, a gaming table component, a service window displayed by a gaming device (e.g., a remote host controlled service window displayed by an EGM) and/or a gaming establishment interface to facilitate the transfer of funds from a third-party account. In certain embodiments, the system enables funds to be deposited in a gaming establishment fund management account, such as a gaming establishment retail account, via activating a line of credit or marker associated with the user.

In certain embodiments, the system enables funds to be deposited in a gaming establishment fund management account, such as a gaming establishment retail account, via a gaming device, such as an EGM. In certain embodiments, the system enables a user that has an amount of cash to utilize a gaming device to convert the cash to an amount deposited into a gaming establishment fund management account (which may be subsequently transferred utilizing a mobile device application). In other embodiments, the system enables funds to be deposited in a gaming establishment fund management account via a gaming device that accepts printed ticket vouchers. In these embodiments, the system enables a user that has one or more printed ticket vouchers to utilize a gaming device to convert the printed ticket voucher to an amount deposited into a gaming establishment fund management account (which may be subsequently transferred utilizing a mobile device application).

In certain embodiments, the system enables funds to be deposited in a gaming establishment fund management account, such as a gaming establishment retail account, via a gaming establishment interface, such as a gaming establishment cage or desk. In certain embodiments, the system enables a user that has an amount of cash to utilize a gaming establishment interface, such as a gaming establishment cage or desk to convert the cash to an amount deposited into a gaming establishment fund management account (which may be subsequently transferred utilizing a mobile device application). In other embodiments, the system enables funds to be deposited in a gaming establishment fund management account via a gaming establishment interface that accepts printed ticket vouchers. In these embodiments, the system enables a user that has one or more printed ticket vouchers to utilize a gaming establishment interface to convert the printed ticket voucher to an amount deposited into a gaming establishment fund management account (which may be subsequently transferred utilizing a mobile device application).

In certain embodiments, the system enables funds to be deposited in a gaming establishment fund management account, such as a gaming establishment retail account, via a kiosk that accepts money. In certain embodiments, the system enables a user that has an amount of cash to utilize a kiosk to convert the cash to an amount deposited into a gaming establishment fund management account (which may be subsequently transferred to a gaming device utilizing a mobile device application). In other embodiments, the system enables funds to be deposited in a gaming establishment fund management account via a kiosk that accepts printed ticket vouchers. In certain embodiments, the system enables a user that has one or more printed ticket vouchers to utilize a kiosk to convert the printed ticket voucher to an amount deposited into a gaming establishment fund management account (which may be subsequently transferred to a gaming device utilizing a mobile device application).

In certain embodiments, the gaming establishment fund management account, such as a gaming establishment retail account, is associated with funds associated with one or more virtual ticket vouchers. In certain embodiments, the system enables a user associated with an amount of virtual ticket vouchers to utilize a gaming device (e.g., an EGM, a component of an EGM) a mobile device running a mobile device application, a kiosk and/or a gaming establishment interface to convert the virtual ticket vouchers to an amount deposited into a gaming establishment fund management account.

In certain embodiments, the system enables a user to fund the gaming establishment fund management account, such as a gaming establishment retail account, independent of the mobile device and independent of the mobile device application. In certain other embodiments, the system enables a user to utilize a mobile device running a mobile device application to fund the gaming establishment fund management account. More specifically and utilizing the example of a kiosk, in one embodiment, to utilize a mobile device and a kiosk to facilitate the funding of a gaming establishment fund management account, the user wirelessly pairs or otherwise connects a mobile device with a kiosk. In one example embodiment, the user moves the mobile device into the range of a wireless receiver of the kiosk. The kiosk and the launched or activated mobile device application of the mobile device negotiate a secure, authenticated connection with the proper functionality, versions and security settings. It should be appreciated that the kiosk wirelessly connects with the mobile device running the mobile device application in the same or similar fashion to how a mobile device is paired or connected with a gaming device of the present disclosure. After connecting the mobile device to the kiosk, the kiosk prompts the user to deposit an amount of funds into the kiosk. In one such embodiment, the kiosk prompts the user to insert one or more bills into a bill acceptor of the kiosk. In another such embodiment, the kiosk additionally or alternatively prompts the user to deposit a physical ticket voucher (associated with an amount of funds) into the kiosk. In another such embodiment, the kiosk additionally or alternatively prompts the user to deposit a card associated with an external account, such as a credit card or debit card into the kiosk. In another such embodiment, the kiosk additionally or alternatively prompts the user to enter information associated with an external account, such as a credit card account, a PayPal® account, a Venmo® account, or a debit card account into the kiosk. In another such embodiment, the kiosk additionally or alternatively prompts the user to deposit an amount of funds into the kiosk using a mobile device electronic fund transfer, such using Apple Pay™ or Android Pay™.

In certain embodiments, upon receiving an amount of funds from the user and the user indicating to transfer the deposited amount of funds in association with the mobile device application, the kiosk communicates with one or more servers to transfer an amount of money to a gaming establishment fund management account (to be drawn upon from the mobile device application of the present disclosure). In another such embodiment, upon receiving an amount of funds from the user and the user indicating to transfer the deposited amount of funds in association with an account or balance associated with the mobile device application, the kiosk communicates with one or more servers, such as a virtual ticket voucher server, to create a virtual ticket voucher associated with the amount of received currency. The system of the present disclosure transfers the created virtual ticket voucher to the gaming establishment fund management account.

It should be appreciated that the electronic fund data transfers of the present disclosure may occur in addition to or as an alternative from cash-based fund transfers and/or ticket voucher-based fund transfers. In one such embodiment, an amount of funds transferred to a gaming establishment device (e.g., an EGM or a retail point-of-sale terminal) is funded via any of an electronic fund transfer, a cash-based fund transfer or a ticket voucher-based fund transfer. In another embodiment, an amount of funds transferred from a gaming establishment device (e.g., an EGM or a gaming table component) is cashed out via any of an electronic fund transfer, a cash-based fund transfer or a ticket voucher-based fund transfer. In another embodiment, an amount of funds transferred to a gaming establishment device (e.g., an EGM or a retail point-of-sale terminal) is funded via an electronic fund transfer or a cash-based fund transfer (but is not funded via any ticket voucher-based fund transfer). In another embodiment, an amount of funds transferred from a gaming establishment device (e.g., an EGM or a gaming table component) is cashed out via an electronic fund transfer or a cash-based fund transfer (but is not cashed out via any ticket voucher-based fund transfer). In another embodiment, an amount of funds transferred to a gaming establishment device (e.g., an EGM or a retail point-of-sale terminal) is funded via an electronic fund transfer or a ticket voucher-based fund transfer (but is not funded via any cash-based fund transfer). In another embodiment, an amount of funds transferred from a gaming establishment device (e.g., an EGM or a gaming table component) is cashed out via an electronic fund transfer or a ticket voucher-based fund transfer (but is not cashed out via any cash-based fund transfer). In another embodiment, an amount of funds transferred to a gaming establishment device (e.g., an EGM or a retail point-of-sale terminal) is funded via an electronic fund transfer (but is not funded via a cash-based fund transfer nor a ticket voucher-based fund transfer). In another embodiment, an amount of funds transferred from a gaming establishment device (e.g., an EGM or a gaming table component) is cashed out via an electronic fund transfer (but is not cashed out via a cash-based fund transfer nor a ticket voucher-based fund transfer).

It should be appreciated that any functionality or process of the present disclosure may be implemented via one or more servers (associated with or independent of any component of any system disclosed herein), one or more gaming establishment devices (e.g., a gaming device such as an EGM or a non-gaming device such as a point-of-sale terminal), one or more components of a gaming establishment device (such as a component of a gaming establishment management system supported by or otherwise located inside the gaming establishment device), or a mobile device application. For example, while certain data or information of the present disclosure is explained as being communicated from a gaming establishment device, or a component associated with a gaming establishment device to a mobile device via one or more wireless communication protocols, such data or information may additionally or alternatively be communicated from one or more servers to a mobile device via one or more wireless communication protocols. Accordingly: (i) while certain functions, features or processes are described herein as being performed by a gaming establishment device or a component associated with a gaming establishment device, such functions, features or processes may alternatively be performed by one or more servers, or one or more mobile device applications, or one or more gaming establishment components, (ii) while certain functions, features or processes are described herein as being performed by one or more mobile device applications, such functions, features or processes may alternatively be performed by one or more servers, one or more gaming establishment devices, one or more components of a gaming establishment device, or one or more gaming establishment components, (iii) while certain functions, features or processes are described herein as being performed by one or more servers, such functions, features or processes may alternatively be performed by one or more gaming establishment devices, one or more components of a gaming establishment device, one or more mobile device applications, or one or more gaming establishment components, and (iv) while certain functions, features or processes are described herein as being performed by one or more gaming establishment components, such functions, features or processes may alternatively be performed by one or more gaming establishment devices, one or more components of a gaming establishment device, or one or more servers.

In certain embodiments, the above-described embodiments of the present disclosure may be implemented in accordance with or in conjunction with zero, one or more components of a gaming establishment fund management system (e.g., a cashless wagering system or a gaming establishment retail system), zero, one or more components of a gaming establishment patron management system, zero, one or more components of a retail point-of-sale system and/or zero, one or more gaming establishment devices. In these embodiments, such components of the gaming establishment fund management system, the gaming establishment patron management system, the retail point-of-sale system and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment fund management system, the component of the gaming establishment patron management system, the component of the retail point-of-sale system and/or the gaming establishment device; (3) accessing memory to configure or reconfigure parameters in the memory according to indicia read from the component of the gaming establishment fund management system, the component of the gaming establishment patron management system, the component of the retail point-of-sale system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the gaming establishment fund management system, the component of the gaming establishment patron management system, the component of the retail point-of-sale system and/or the gaming establishment device, while in other embodiments, at least one component of the controller resides outside of the housing of the component of the gaming establishment fund management system, the component of the gaming establishment patron management system, the component of the retail point-of-sale system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment fund management system, the component of the gaming establishment patron management system, the component of the retail point-of-sale system and/or the gaming establishment device disclosed herein. In certain embodiments, the at least one memory device resides within the housing of the component of the gaming establishment fund management system, the component of the gaming establishment patron management system, the component of the retail point-of-sale system and/or the gaming establishment device, while in other embodiments at least one component of the at least one memory device resides outside of the housing of the component of the gaming establishment fund management system, the component of the gaming establishment patron management system, the component of the retail point-of-sale system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment fund management system, the component of the gaming establishment patron management system, the component of the retail point-of-sale system and/or the gaming establishment device; (2) associations between configuration indicia read from a component of the gaming establishment fund management system with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment fund management system, the component of the gaming establishment patron management system, the component of the retail point-of-sale system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the player's computer, partly on the player's computer, as a stand-alone software package, partly on the player's computer and partly on a remote computer or entirely on the remote computer or server. In the latter scenario, the remote computer may be connected to the player's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment fund management system, the component of the gaming establishment patron management system, the component of the retail point-of-sale system and/or the gaming establishment device to control the component of the gaming establishment fund management system, the component of the gaming establishment patron management system, the component of the retail point-of-sale system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the gaming establishment fund management system to implement at least part of the present disclosure. In other embodiments, part or all of the program code and/or the operating data is downloaded to the at least one memory device of the component of the gaming establishment fund management system, the component of the gaming establishment patron management system, the component of the retail point-of-sale system and/or the gaming establishment device through any suitable data network described above (such as an Internet or intranet).

The at least one memory device also stores a plurality of device drivers. Examples of different types of device drivers include device drivers for the component of the gaming establishment fund management system, the component of the gaming establishment patron management system, the component of the retail point-of-sale system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment fund management system, the component of the gaming establishment patron management system, the component of the retail point-of-sale system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™ near-field communications (e.g., using near-field magnetics), 802.11 (WiFi), etc. In one embodiment, when one type of a particular device is exchanged for another type of the particular device, the at least one processor of the component of the gaming establishment fund management system, the component of the gaming establishment patron management system, the component of the retail point-of-sale system and/or the gaming establishment device loads the new device driver from the at least one memory device to enable communication with the new device. For instance, one type of card reader in the component of the gaming establishment fund management system, the component of the gaming establishment patron management system, the component of the retail point-of-sale system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the gaming establishment fund management system, the component of the gaming establishment patron management system, the component of the retail point-of-sale system and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the gaming establishment fund management system, the component of the gaming establishment patron management system, the component of the retail point-of-sale system and/or the gaming establishment device. In various embodiments, the display devices serve as digital glass configured to aspects of the gaming establishment in which the component of the gaming establishment fund management system, the component of the gaming establishment patron management system, the component of the retail point-of-sale system and/or the gaming establishment device is located. In various embodiments, the component of the gaming establishment fund management system, the component of the gaming establishment patron management system, the component of the retail point-of-sale system and/or the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the gaming establishment fund management system, the component of the gaming establishment patron management system, the component of the retail point-of-sale system and/or the gaming establishment device receives an actuation, the component of the gaming establishment fund management system, the component of the gaming establishment patron management system, the component of the retail point-of-sale system and/or the gaming establishment device causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the gaming establishment fund management system, the component of the gaming establishment patron management system, the component of the retail point-of-sale system and/or the gaming establishment device provides dynamic sounds coupled with attractive multimedia images displayed on one or more of the display devices to provide an audio-visual representation or to otherwise display full-motion video with sound to attract players to the component of the gaming establishment fund management system, the component of the gaming establishment patron management system, the component of the retail point-of-sale system and/or the gaming establishment device. In certain embodiments, the component of the gaming establishment fund management system, the component of the gaming establishment patron management system, the component of the retail point-of-sale system and/or the gaming establishment device displays a sequence of audio and/or visual attraction messages during idle periods to attract potential players to the component of the gaming establishment fund management system, the component of the gaming establishment patron management system, the component of the retail point-of-sale system and/or the gaming establishment device. The videos may be customized to provide any appropriate information.

The at least one input device may include any suitable device that enables an input signal to be produced and received by the at least one processor of the component of the gaming establishment fund management system, the component of the gaming establishment patron management system, the component of the retail point-of-sale system and/or the gaming establishment device. In one embodiment, the at least one input device includes a payment device configured to communicate with the at least one processor of the component of the gaming establishment fund management system, the component of the gaming establishment patron management system, the component of the retail point-of-sale system and/or the gaming establishment device to fund the component of the gaming establishment fund management system, the component of the gaming establishment patron management system, the component of the retail point-of-sale system and/or the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the component of the gaming establishment fund management system, the component of the gaming establishment patron management system, the component of the retail point-of-sale system and/or the gaming establishment device to be funded via an electronic funds transfer, such as a transfer of funds from a bank account. In another embodiment, the component of the gaming establishment fund management system, the component of the gaming establishment patron management system, the component of the retail point-of-sale system and/or the gaming establishment device includes a payment device configured to communicate with a mobile device of a player, such as a mobile phone, a radio frequency identification tag, or any other suitable wired or wireless device, to retrieve relevant information associated with that player to fund the component of the gaming establishment fund management system, the component of the gaming establishment patron management system, the component of the retail point-of-sale system and/or the gaming establishment device. When the component of the gaming establishment fund management system, the component of the gaming establishment patron management system, the component of the retail point-of-sale system and/or the gaming establishment device is funded, the at least one processor determines the amount of funds entered and displays the corresponding amount.

In various embodiments, the at least one input device includes a plurality of buttons that are programmable by the component of the gaming establishment fund management system, the component of the gaming establishment patron management system, the component of the retail point-of-sale system and/or the gaming establishment device operator to, when actuated, cause the component of the gaming establishment fund management system, the component of the gaming establishment patron management system, the component of the retail point-of-sale system and/or the gaming establishment device to perform particular functions. For instance, such buttons may be hard keys, programmable soft keys, or icons icon displayed on a display device of the component of the gaming establishment fund management system, the component of the gaming establishment patron management system, the component of the retail point-of-sale system and/or the gaming establishment device that are actuatable via a touch screen of the component of the gaming establishment fund management system, the component of the gaming establishment patron management system, the component of the retail point-of-sale system and/or the gaming establishment device or via use of a suitable input device of the component of the gaming establishment fund management system, the component of the gaming establishment patron management system, the component of the retail point-of-sale system and/or the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the gaming establishment fund management system, the component of the gaming establishment patron management system, the component of the retail point-of-sale system and/or the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the gaming establishment fund management system, the component of the gaming establishment patron management system, the component of the retail point-of-sale system and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the gaming establishment fund management system, the component of the gaming establishment patron management system, the component of the retail point-of-sale system and/or the gaming establishment device, such as one or more rechargeable power sources (e.g., rechargeable batteries) located at the component of the gaming establishment fund management system, the component of the gaming establishment patron management system, the component of the retail point-of-sale system and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the gaming establishment fund management system, the component of the gaming establishment patron management system, the component of the retail point-of-sale system and/or the gaming establishment device; detecting the presence and/or identity of various persons (e.g., players, casino employees, etc.), devices (e.g., user input devices), and/or systems within a predetermined proximity to the component of the gaming establishment fund management system, the component of the gaming establishment patron management system, the component of the retail point-of-sale system and/or the gaming establishment device.

The at least one data preservation component is configured to detect or sense one or more events and/or conditions that, for example, may result in damage to the component of the gaming establishment fund management system, the component of the gaming establishment patron management system, the component of the retail point-of-sale system and/or the gaming establishment device and/or that may result in loss of information associated with the component of the gaming establishment fund management system, the component of the gaming establishment patron management system, the component of the retail point-of-sale system and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected player movements and/or gestures to determine appropriate player input information relating to the detected player movements and/or gestures. For example, in one embodiment, the at least one motion/gesture analysis and interpretation component is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source enables the component of the gaming establishment fund management system, the component of the gaming establishment patron management system, the component of the retail point-of-sale system and/or the gaming establishment device to operate in a mobile environment.

The at least one geolocation module is configured to acquire geolocation information from one or more remote sources and use the acquired geolocation information to determine information relating to a relative and/or absolute position of the component of the gaming establishment fund management system, the component of the gaming establishment patron management system, the component of the retail point-of-sale system and/or the gaming establishment device. For example, in one implementation, the at least one geolocation module is configured to receive GPS signal information for use in determining the position or location of the component of the gaming establishment fund management system, the component of the gaming establishment patron management system, the component of the retail point-of-sale system and/or the gaming establishment device. In another implementation, the at least one geolocation module is configured to receive multiple wireless signals from multiple remote devices (e.g., component of the gaming establishment fund management system, the gaming establishment patron management system, the retail point-of-sale system and/or the gaming establishment devices, servers, wireless access points, etc.) and use the signal information to compute position/location information relating to the position or location of the component of the gaming establishment fund management system, the component of the gaming establishment patron management system, the component of the retail point-of-sale system and/or the gaming establishment device.

The at least one user identification module is configured to determine the identity of the current user or current owner of the component of the gaming establishment fund management system, the component of the gaming establishment patron management system, the component of the retail point-of-sale system and/or the gaming establishment device. For example, in one embodiment, the current user is required to perform a login process at the component of the gaming establishment fund management system, the component of the gaming establishment patron management system, the component of the retail point-of-sale system and/or the gaming establishment device in order to access one or more features. Alternatively, the component of the gaming establishment fund management system, the component of the gaming establishment patron management system, the component of the retail point-of-sale system and/or the gaming establishment device is configured to automatically determine the identity of the current user based on one or more external signals, such as an RFID tag or badge worn by the current user and that provides a wireless signal to the component of the gaming establishment fund management system, the component of the gaming establishment patron management system, the component of the retail point-of-sale system and/or the gaming establishment device that is used to determine the identity of the current user. In at least one embodiment, various security features are incorporated into the component of the gaming establishment fund management system, the component of the gaming establishment patron management system, the component of the retail point-of-sale system and/or the gaming establishment device to prevent unauthorized users from accessing confidential or sensitive information.

The at least one information filtering module is configured to perform filtering (e.g., based on specified criteria) of selected information to be displayed at one or more displays of the component of the gaming establishment fund management system, the component of the gaming establishment patron management system, the component of the retail point-of-sale system and/or the gaming establishment device.

In various embodiments, the component of the gaming establishment fund management system, the component of the gaming establishment patron management system, the component of the retail point-of-sale system and/or the gaming establishment device includes a plurality of communication ports configured to enable the at least one processor of the component of the gaming establishment fund management system, the component of the gaming establishment patron management system, the component of the retail point-of-sale system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the gaming establishment fund management system, the component of the gaming establishment patron management system, the component of the retail point-of-sale system and/or the gaming establishment device has a support structure, housing, or cabinet that provides support for a plurality of the input devices and the output devices of the component of the gaming establishment fund management system, the component of the gaming establishment patron management system, the component of the retail point-of-sale system and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor responsive to an attempted retail purchase at a point-of-sale terminal, cause the processor to:
determine if any enhanced security measures are associated with the attempted retail purchase,
responsive to the determination being that an enhanced security measure is associated with the attempted retail purchase:
determine if the enhanced security measure is satisfied by a user,
responsive to the determination being that the enhanced security measure is satisfied and responsive to a determination that a balance of a gaming establishment account associated with the user includes at least an amount of funds to complete the attempted retail purchase:
communicate data which results in the point-of-sale terminal completing the attempted retail purchase, and
modify the balance of the gaming establishment account associated with the user based on an amount of funds to complete the attempted retail purchase, and
responsive to the determination being that the enhanced security measure is not satisfied and responsive to the determination that the balance of the gaming establishment account associated with the user includes at least the amount of funds to complete the attempted retail purchase, communicate data which results in the point-of-sale terminal not completing the attempted retail purchase.

2. The system of claim 1, wherein when executed by the processor, the instructions cause the processor to determine if any enhanced security measures are associated with the attempted retail purchase based on one of the amount of funds to complete the attempted retail purchase, a location of the point-of-sale terminal, a time of the attempted retail purchase, a channel of commerce associated with the attempted retail purchase, a rate of consumption associated with the gaming establishment account, and the balance of the gaming establishment account.

3. The system of claim 2, wherein when executed by the processor, the instructions cause the processor to determine if any enhanced security measures are associated with the attempted retail purchase based on another of the amount of funds to complete the attempted retail purchase, the location of the point-of-sale terminal, the time of the attempted retail purchase, the channel of commerce associated with the attempted retail purchase, the rate of consumption associated with the gaming establishment account, and the balance of the gaming establishment account.

4. The system of claim 1, wherein when executed by the processor, the instructions cause the processor to determine if the enhanced security measure is satisfied by the user based on data received from a mobile device associated with the user.

5. The system of claim 4, wherein the data received from the mobile device comprises at least one of a personal identification number inputted by the user and a verification of the attempted retail purchase inputted by the user.

6. The system of claim 1, wherein when executed by the processor, the instructions cause the processor to determine if the enhanced security measure is satisfied by the user based on data received from the point-of-sale terminal.

7. The system of claim 6, wherein the data received from the point-of-sale terminal comprises a verification of an identity of the user based on a presentation of picture identification documentation.

8. The system of claim 1, wherein when executed by the processor responsive to the determination being that no enhanced security measure is associated with the attempted retail purchase and responsive to the determination that the balance of the gaming establishment account associated with the user includes at least the amount of funds to complete the attempted retail purchase, the instructions cause the processor to, independent of any satisfaction of any security measures, communicate data which results in the point-of-sale terminal completing the attempted retail purchase, and modify the balance of the gaming establishment account associated with the user based on the amount of funds to complete the attempted retail purchase.

9. The system of claim 1, wherein when executed by the processor, the instructions cause the processor to associate any enhanced security measures with the attempted retail purchase responsive to an input received from the user.

10. A system comprising:
a processor; and
a memory device that stores a plurality of instructions that, when executed by the processor responsive to an attempted retail purchase at a point-of-sale terminal, cause the processor to:
determine if any enhanced security measures are associated with a gaming establishment account,
responsive to the determination being that an enhanced security measure is associated with the gaming establishment account and responsive to a determination that the enhanced security measure is satisfied by a user, determine if a balance of the gaming establishment account associated with the user includes at least an amount of funds to complete the attempted retail purchase, and
responsive to the determination being that the enhanced security measure is associated with the gaming establishment account and responsive to a determination that the enhanced security measure is not satisfied by the user, communicate data which results in the point-of-sale terminal not completing the attempted retail purchase.

11. The system of claim 10, wherein when executed by the processor, the instructions cause the processor to determine if any enhanced security measures are associated with the gaming establishment account based on at least one of the amount of funds to complete the attempted retail purchase, a location of the point-of-sale terminal, a time of the attempted retail purchase, a channel of commerce associated with the attempted retail purchase, a rate of consumption associated with the gaming establishment account, and the balance of the gaming establishment account.

12. A method of operating a system responsive to an attempted retail purchase at a point-of-sale terminal, the method comprising:
determining, by a processor, if any enhanced security measures are associated with the attempted retail purchase,
responsive to the determination being that an enhanced security measure is associated with the attempted retail purchase:
determining, by the processor, if the enhanced security measure is satisfied by a user,
responsive to the determination being that the enhanced security measure is satisfied and responsive to a determination that a balance of a gaming establishment account associated with the user includes at least an amount of funds to complete the attempted retail purchase:
communicating data which results in the point-of-sale terminal completing the attempted retail purchase, and
modifying, by the processor, the balance of the gaming establishment account associated with the user based on an amount of funds to complete the attempted retail purchase, and
responsive to the determination being that the enhanced security measure is not satisfied and responsive to the determination that the balance of the gaming establishment account associated with the user includes at least the amount of funds to complete the attempted retail purchase, communicating data which results in the point-of-sale terminal not completing the attempted retail purchase.

13. The method of claim 12, further comprising determining, by the processor, if any enhanced security measures are associated with the attempted retail purchase based on one of the amount of funds to complete the attempted retail purchase, a location of the point-of-sale terminal, a time of the attempted retail purchase, a channel of commerce associated with the attempted retail purchase, a rate of consumption associated with the gaming establishment account, and the balance of the gaming establishment account.

14. The method of claim 13, further comprising determining, by the processor, if any enhanced security measures are associated with the attempted retail purchase based on another of the amount of funds to complete the attempted retail purchase, the location of the point-of-sale terminal, the time of the attempted retail purchase, the channel of commerce associated with the attempted retail purchase, the rate of consumption associated with the gaming establishment account, and the balance of the gaming establishment account.

15. The method of claim 12, further comprising determining, by the processor, if the enhanced security measure is satisfied by the user based on data received from a mobile device associated with the user.

16. The method of claim 15, wherein the data received from the mobile device comprises at least one of a personal identification number inputted by the user and a verification of the attempted retail purchase inputted by the user.

17. The method of claim 12, further comprising determining, by the processor, if the enhanced security measure is satisfied by the user based on data received from the point-of-sale terminal.

18. The method of claim 17, wherein the data received from the point-of-sale terminal comprises a verification of an identity of the user based on a presentation of picture identification documentation.

19. The method of claim 12, further comprising, responsive to the determination being that no enhanced security measure is associated with the attempted retail purchase and responsive to the determination that the balance of the gaming establishment account associated with the user includes at least the amount of funds to complete the attempted retail purchase, independent of any satisfaction of any security measures, communicating data which results in the point-of-sale terminal completing the attempted retail purchase, and modifying, by the processor, the balance of the gaming establishment account associated with the user based on the amount of funds to complete the attempted retail purchase.

20. The method of claim 12, further comprising associating, by the processor, any enhanced security measures with the attempted retail purchase responsive to an input received from the user.
